(19) United States
(12) Patent Application Publication
(10) Pub. No.: US 2004/0065119 A1
(43) Pub. Date: Apr. 8, 2004

(54) Apparatus and method for reducing end effect of an optical fiber preform

(75) Inventors: Shunhe Xiong, Alpharetta, GA (US); Zhi Zhou, Lawrenceville, GA (US); Ralph Corley, Suwanee, GA (US); Bella Boex, Alpharetta, GA (US); Christopher Gallagher, Atlanta, GA (US); Michael Overbeck, Lilburn, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Fitel U.S.A. Corporation

(21) Appl. No.: 10/263,220

(22) Filed: Oct. 2, 2002

(51) Int. Cl. C03B 37/028

(52) U.S. Cl. 65/412; 65/501

(57) ABSTRACT

Apparatus and methods are provided for reducing end effect on a preform assembly during manufacture of optical fiber. The present invention provides apparatus and methods that apply a first vacuum pressure to a preform assembly during a first portion of the draw of optical fiber from the preform assembly and a second lesser vacuum pressure during a second portion of the draw. The second vacuum pressure may be a step down pressure or a gradual or an incremental decrease in pressure over time. The present invention further provides apparatus and methods that use an intermediate rod such as a dummy preform core rod and/or a support rod placed at the back of the preform core rod, wherein the preform end effect occurs on the dummy preform core rod, as opposed to the core rod of the preform assembly or is eliminated altogether by the support rod.

### BACKGROUND OF THE INVENTION

1. Field of the Invention

The invention relates to optical fibers and in particular to the manufacturing of optical fibers by the use of preforms.

2. Description of Related Art

Optical fibers are generally manufactured by heating a preform assembly comprised of glass or some other optically transmissive material to a temperature where the preform assembly material may be “drawn” from the preform assembly to form the optical fiber. The diameter of the drawn optical fiber is controlled, in part, by the speed at which the optical fiber is drawn from the molten preform assembly. A preform assembly is generally cylindrical and comprises a preform core rod that is a solid piece of the material that will form the core of the optical fiber and may be surrounded by one or more layers of cladding material. The preform assembly has a much larger diameter than the resultant optical fiber and its length varies, depending upon the amount of optical fiber to be “drawn” from the preform.

The one or more layers of cladding material that surround a preform core rod in a preform assembly may or may not be comprised of the same material as the preform core rod. If the preform core rod is cylindrical, then the cladding material is generally tube-shaped with the preform core rod placed into the center of the cladding tube. Additional cladding layers may surround the cladding layer closest to the preform core rod. For example, if the preform core rod is cylindrical in shape, then the cladding layers may be concentric tubes with increasing diameters such that the preform core rod is at the center, a first cladding layer surrounds the preform core rod, a second cladding layer surrounds the first cladding layer, etc. There is a small amount of space between the preform core rod and the first cladding layer and between each cladding layer thereon.

If the preform core rod is surrounded by one or more layers of cladding material, the cladding material is typically made to collapse about the preform core rod during manufacture such that there is no space between the preform core rod and the first cladding layer and between subsequent cladding layers. In conventional systems, the cladding material collapses onto the core rod a certain length from the end of the preform assembly from which the optical fiber is drawn. The cladding is collapsed around the preform core rod by heating the cladding material. This may occur as a separate preparation step called “rod in tube” (“RIT”), where the draw end of the cladding material is collapsed around the preform core rod, and then the preform assembly is placed into the fiber draw manufacturing line, and the optical fiber is drawn from the collapsed end as it is heated. The subsequent collapse occurs as part of the draw manufacturing process. In this instance, the cladding is collapsed onto the preform core rod by the heating device that is used to soften the preform core rod and cladding material so that the optical fiber may be drawn from it. In either case, the cladding material is continually collapsed around the preform core rod as the preform assembly is fed into the manufacturing heating device and the optical fiber is drawn from the heated material.

One method of manufacturing optical fiber clamps one end of the preform assembly into a device that slowly inserts the assembly into a heating device. This collapses the cladding material about the preform core rod and softens the preform core rod and cladding material such that it may be drawn from the heated end of the preform assembly to form an optical fiber. This collapse of the cladding material effectively seals the preform assembly such that a vacuum may be applied to areas between the preform core rod and the first cladding layer and between the subsequent cladding layers. The term vacuum as used herein refers to vacuum pressure, which is pressure of a system that is below atmospheric pressure. This vacuum helps prevent particle contamination, reduces air-lines in the optical fiber, helps hold the preform core rod and cladding in the clamping mechanism and facilitates the collapse of the cladding onto the preform core rod or other cladding layers.

Collapsing the cladding about the preform core rod also aligns the preform core rod and cladding tubes in a concentric manner that affects performance parameters of the optical fiber, such as eccentricity and mode field diameter. Eccentricity is caused by a radial misalignment between the cladding tube and the preform core rod. Eccentricity should be minimized, otherwise the resultant drawn optical fiber core may be insufficiently aligned with the cladding, such that it inhibits proper splicing of the drawn fiber to another fiber. The above-described method of manufacturing optical fibers is disclosed in U.S. Pat. No. 4,820,322 issued on Apr. 11, 1989 to Baumgart et al., and is incorporated herein.

As the preform assembly is heated and drawn into the optical fiber, it forms an optical fiber with a core and at least one layer of cladding. If the preform core rod is surrounded by only one layer of cladding and the collapse of the overcladding layer onto the core rod occurs mainly in the draw manufacturing process, the manufacturing process is generally referred to as overcladding during draw (“ODD”). In a similar manner, if the preform core rod is surrounded by two layers of cladding and the collapse of the overcladding layer onto the core rod occurs mainly in the draw manufacturing process, the manufacturing process is generally referred to as double overcladding during draw (“DODD”). Finally, the optical fiber may be manufactured with no overcladding during draw. This is generally referred to as “non-ODD.”

During the drawing of optical fiber from a preform assembly with ODD, DODD, or non-ODD, the optical fiber that is drawn from near the end where the preform assembly is clamped into a chuck tends to exhibit unsatisfactory performance parameters, typically referred to as “end effect.” In particular, the fiber drawn from this section of the preform assembly may lack satisfactory dispersion uniformity and mode field diameter (“MFD”). MFD is generally an expression of distribution of the irradiance, i.e., the optical power, across the end face of an optical fiber.

Also, the fiber from the interface of the pre-collapsed region may exhibit the same unsatisfactory performance parameters mentioned above. This phenomenon that happens at the sealed or distal end of preform is referred as “end effect”.

End effect at the proximal or clamped end is generally thought to be caused by the vacuum (or lack thereof) that is applied to the preform assembly during the process of drawing optical fiber. Specifically, as the preform assembly is fed into the heating device and nears the end where it is clamped, the preform core rod is softened by the high temperature of the heating device used for the draw of the optical fiber. This heating of the preform core rod along with the vacuum results in a change in the flow rate of the preform core rod material and the cladding material. This, in turn, results in a change of the ratio of the core outer diameter to the cladding outer diameter (“d/D ratio”) in optical fiber drawn from the clamped end of the preform assembly, as compared to the d/D ratio of fiber drawn from the middle of the preform assembly. This variance in the d/D ratio affects the performance characteristics of the optical fiber, including dispersion uniformity, eccentricity and MFD.

Typically, optical fiber drawn from the end where the preform assembly is clamped must be scrapped because of these varying performance characteristics. Scrapping of this non-conforming optical fiber reduces the amount of optical fiber that may be drawn from a preform assembly and is an inefficient use of manufacturing resources. Preform assemblies are very expensive, and significant cost savings may be realized if the portion of the preform assembly subject to end effect could be used in manufacture of optical fiber.

Therefore, methods and systems are needed that overcome the challenges of the prior art and allow more of the clamped end of the preform assembly to be used to produce drawn optical fiber with acceptable and uniform performance characteristics. Further, methods and systems are needed to make use of more of the sealed end of a preform assembly when such preform assembly is prepared in a RIT technique.

### BRIEF SUMMARY OF THE INVENTION

The present invention overcomes the above-mentioned challenged as well as other challenges of the prior art through the use of a variable vacuum on the preform assembly or the use of an intermediate rod such as a support rod or a dummy preform core rod at the back of core rod, or combination of these two methods for the clamped or proximal end, and shorter pre-collapsed length for the sealed or distal end.

As previously provided herein, preform assembly end effect is a term given to optical fiber drawn from the end zone of an ODD, DODD, or non-ODD preform assembly where the flow rate of the preform assembly core rod, as compared to the flow rate of the overcladding material, changes such that the d/D ratio of the optical fiber is altered. This altered d/D ratio may cause the optical fiber drawn from the end zone region to be scrapped because of unacceptable performance characteristics. The end zone may generally be thought of as a length of the preform assembly at the end of the preform assembly that is clamped into the device that holds it during the optical fiber draw process. Preform assembly end effect is generally thought to be caused by substantially all of the remaining preform core rod becoming softened in the preform end zone. When this happens, in a low vacuum or the absence of a vacuum, gravitational forces cause the preform core rod to swell at the end where the optical fiber is drawn, thus affecting the flow rate of the preform core rod material and, in turn, the d/D ratio of the optical fiber. End effect may also occur, if the entire remaining preform core rod softens in the presence of a certain vacuum that overcomes the gravitational effect on the molten preform core rod. In this instance, the end of the preform assembly core rod, from which the optical fiber is drawn, will thin, once again affecting the flow of the preform core rod material and the d/D ratio of the optical fiber.

The present invention reduces preform end effect either by adjusting the vacuum on the preform assembly as the entire remaining preform core rod becomes softened, or by effectively increasing the length of the preform core rod through the use of an intermediate rod such as a support rod or a dummy preform core rod.

The variable vacuum approach features a reduced vacuum as the end zone approaches the heating device used to soften the preform assembly for drawing it into optical fiber. Generally, the vacuum level used during the draw of an ODD or DODD preform is, for example, approximately 25 inches Hg, and remains constant during the draw of the entire preform. In an embodiment of the present invention, the vacuum is reduced as the end zone of the preform assembly is approached. The reduced vacuum on the preform assembly as the preform assembly end zone approaches the heating device allows the flow rate of the molten preform assembly core rod in the end zone region of the preform assembly to be substantially similar to the flow rate of the molten preform assembly core rod in the middle of the preform assembly when under a constant vacuum, thus the optical fiber d/D ratio is substantially uniform for the entire preform assembly.

The variable vacuum technique may be used with or without an intermediate rod such as a support rod or a dummy preform core rod. The dummy preform core rod or support rod technique may also be used with a constant vacuum or with variable vacuum on the preform assembly. A dummy preform core rod or support rod, in this context, is a rod of material that is placed at the end zone of the preform assembly and that is in direct contact with the preform assembly core rod. The support rod and the dummy preform core rod serve, in effect, to lengthen the preform core rod. When the end zone of the preform assembly is reached during the draw of the optical fiber, during the presence of the dummy preform core rod, the preform core rod and the dummy preform core rod will be softened, and the molten material from the preform core rod and the dummy preform core rod will essentially flow continuously and uniformly and the fiber from the end of core rod will have the same of similar d/D ratio and satisfactory properties. When the end zone of the preform assembly is reached during the draw of the optical fiber, in the presence of support rod, only a portion of the support rod will become molten and the rest of the support rod will remain solid and thus prevent the thinning of preform core rod by vacuum. Therefore, the d/D ratio of the optical fiber will not change substantially at the end zone of the preform assembly.

Furthermore, the interface between the dummy preform core rod or support rod and the preform core rod will provide a “signature” in the form of a speed and cladding excursion and an air line in the optical fiber. This excursion can be detected during the manufacturing process so that the dummy preform core rod or support rod material will not be used to draw optical fiber for commercial sale.

It is therefore an aspect of this invention is to provide systems and methods to vary the vacuum applied to a preform assembly as the end zone of the assembly is drawn into optical fiber to thereby reduce preform end effect.

Another aspect of this invention is to provide systems and methods to reduce preform end effect by effectively extending a preform core rod through the use of a dummy preform core rod or a support rod.

Another aspect of this invention is to reduce the amount of non-conforming fiber by reducing the initial length of the overcladding that is collapsed onto the preform core rod in a RIT process, when the preform is assembled and the sealed or distal end of the preform is pre-collapsed.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIGS. 1A and 1B illustrate a sectional view and a cross-sectional view, respectively, of an exemplary preform assembly in one embodiment of the present invention;

FIG. 2 is an exemplary embodiment of a vertical draw tower arrangement for manufacturing optical fiber according to one embodiment of the present invention;

FIG. 3 is an exemplary embodiment of a preform assembly according to one embodiment of the present invention illustrating the reduced collapse of the cladding tubes onto the preform core rod to reduce the amount of non-conforming fiber;

FIG. 4 is an exemplary embodiment of an arrangement in which one or more cladding tubes are collapsed onto a preform core rod during the drawing of optical fiber according to one embodiment of the present invention;

FIGS. 5A and 5B are exemplary illustrations of the drawing of optical fiber from the middle and from the end zone of a preform assembly in the presence of a vacuum, respectively according to embodiments of the present invention;

FIGS. 6A, 6B and 6C are exemplary illustrations of various applications of variable vacuum to the end zone of a preform assembly in differing embodiments of the present invention; and

FIGS. 7A and 7B are exemplary embodiments of the use of a support rod or a dummy preform core rod, respectively, to reduce preform end effect according to embodiments of the present invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

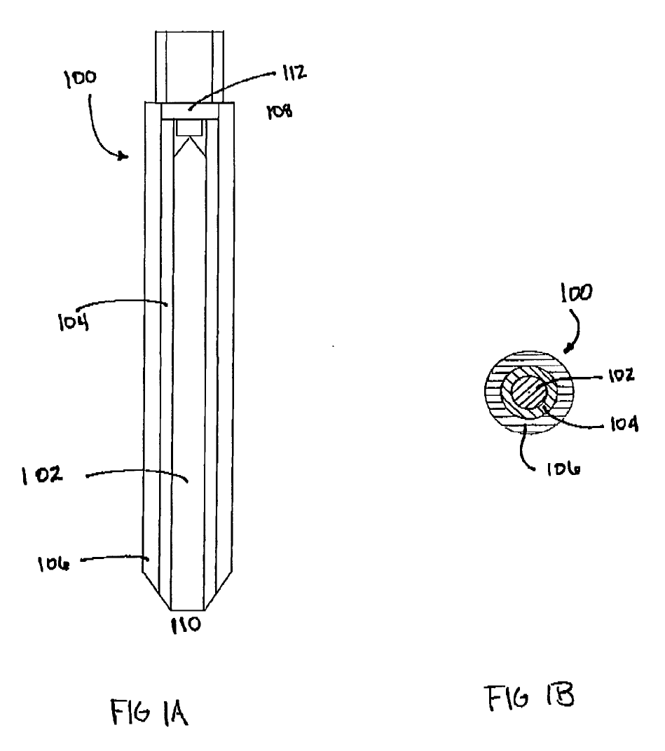

A preform assembly 100, for example, as shown in exemplary FIGS 1A and 1B, is generally comprised of a solid cylindrical preform core rod 102 typically made of synthetic silica doped with other chemicals, though other materials may be utilized. Disposed about this preform core rod 102 may be one or more cylindrical cladding tubes, 104 and 106. These cladding tubes are also generally synthetic silica, and they also may be doped with other chemicals. The first cladding tube 104 has an inner diameter just slightly larger than the outer diameter of the preform core rod 102. Subsequent cladding tubes will have an inner diameter just slightly larger than the outer diameter of the immediately preceding cladding tube. The embodiment illustrated in FIGS. 1A and 1B has two cladding tubes, the second cladding tube 106 surrounds the first cladding tube 104. The preform assembly 100 generally has two ends, a proximal end 108 and a distal end 110. The proximal end 108 is generally clamped or mounted into a chuck 112, whereby the preform assembly 100 is suspended or held as the preform assembly is fed into a heating device and the optical fiber is drawn from the molten distal end 110 of the preform assembly 100 during the optical fiber draw manufacturing process.

Importantly, the distal end 110 may be sealed prior to mounting the proximal end 108 in the chuck 112 by collapsing the cladding tubes 104, 106 onto the preform core rod 102 in a separate step generally known as rod in tube (“RIT”). Alternatively, the distal end 110 may be sealed as the preform assembly 100 is fed into the heating device during the optical fiber manufacturing process. In either case, the cladding tubes 104, 106 are continuously collapsed onto the preform core rod 102, as the preform assembly 100 is inserted into the heating device during the optical fiber manufacturing process.

If the preform assembly 100 has one overcladding tube over the preform core rod 102 and the collapse of the overcladding tube onto the preform core rod occurs mainly during the fiber draw process, the optical fiber manufacturing process is generally referred to as overcladding during draw (“ODD”). If the preform assembly has two overcladding tubes over the preform core rod and the collapse of the overcladding tubes onto the preform core rod occurs mainly during the fiber draw process, the manufacturing process is generally referred to as double overcladding during draw (“DODD”). The optical fiber may also be manufactured with no overcladding during draw; this is generally referred to as “non-ODD.”

Optical fiber manufactured in the described manner is required to meet certain performance characteristics, else it will be scrapped. These performance characteristics may include, for example, uniformity of dispersion, eccentricity, and mode field diameter (“MFD”). Generally, a range is given for such performance characteristics. If the manufactured optical fiber is tested and falls outside one or more of the designated ranges, it is scrapped. Scrapping manufactured optical fiber is expensive and inefficient.

Eccentricity is generally caused by a radial misalignment between the cladding tubes, 104 and 106, and the preform core rod 102. It should be minimized, otherwise the resultant drawn optical fiber core may be too eccentric, which inhibits proper splicing of the drawn fiber to a second drawn fiber. MFD is generally an expression of distribution of the irradiance, i.e., the optical power, across the end face of an optical fiber.

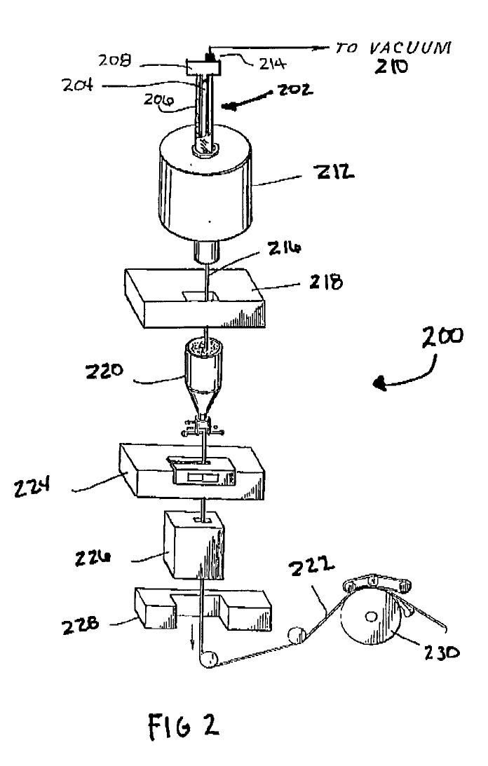

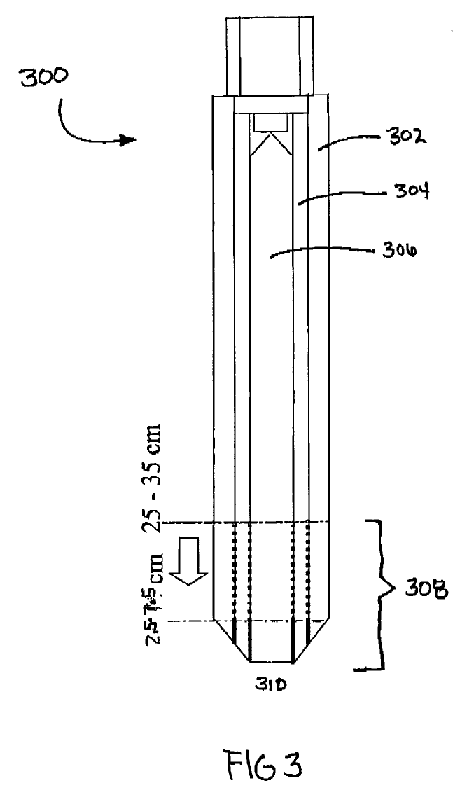

FIG. 2 is an embodiment of a vertical draw tower arrangement 200 for drawing optical fiber. A preform assembly 202 comprised of a preform core rod 204 and one or more cladding tubes 206 is clamped into a chuck 208 that holds the core rod 204 and the cladding tubes 206 in place. The chuck 208 also has means to apply a vacuum 210, (such as a flow control device in the form of a vacuum device), between the preform core rod 204 and the first cladding tube 206, and between subsequent cladding tubes. This vacuum 210 via a vacuum device facilitates the collapse of the cladding tubes 206 onto the core rod as the preform assembly 202 is heated, removes particles and contaminants from between the cladding tubes 206 and from between the first cladding tube 206 and the preform core rod 204, and helps prevent air lines and bubbles from forming in the optical fiber. This form of optical fiber manufacture utilizing a vacuum is disclosed in U.S. Pat. No. 4,820,322 issued on Apr. 11, 1989 to Baumgart et al.

In FIG. 2, a draw furnace 212 provides heat energy directly into both the cladding tubes 206 and the preform core rod 204. An axisymmetric draw force acts on both the preform core rod 204 and cladding tubes 206 during co-drawing of the preform core rod 204 and the cladding tubes 206. The fluidity of the molten core rod 204 and cladding tubes 206 and the axisymmetric draw force acting on them in the co-drawing technique for overcladding provide a self-centering mechanism for the preform assembly 202, which tends to oppose any eccentricity of a preform core rod 204 in the cladding tubes 206.

As can be seen in FIG. 2, entrance of the preform rod 204 into the cladding tube 206 is provided with a vacuum coupling 214 to seal the entrance and allow the volume between the inner wall of the cladding tube 206 and the outer surface of the core rod 204 and between subsequent cladding tubes to be maintained at a suitable pressure. The preform rod 204 and the cladding tube 206 extend into the furnace 212, which may be a zirconia induction furnace, for example. As the preform rod 204 and the cladding tube 206 are fed into the furnace 212, a source of vacuum (not shown) 210 is connected through the vacuum coupling 214 to the space between the cladding tube 206 and the preform core rod 204 and between subsequent cladding tubes. Successive portions of the length of the cladding tube 206 within the furnace 212 are caused to be collapsed onto the preform rod 204 and an optical fiber 216 is drawn from the overclad preform assembly 202. In the draw-down portion of the furnace 212, where the cladding tube 206 and the rod 204 become fluid at the same time, the draw force from the fiber 216 is thought to provide a self-centering mechanism for the cladding tube 206 and the core rod 204. Alignment is aided by an axially symmetric drawing tension on both the preform rod 204 and the cladding tube 206.

The diameter of the drawn optical fiber 216 is measured by a measurement device 218 at a point shortly after the optical fiber exits from the furnace 212, and this measured value becomes an input to a control system. Within the control system, the measured diameter is compared to a desired value, and an output signal is generated to adjust the draw speed, such that the optical fiber diameter approaches the desired value.

After the diameter of the optical fiber 216 is measured, one or more protective coatings may be applied to it by an apparatus 220. Thereafter, the coated fiber 222 passes through a centering gauge 224, a device 226 for treating the coating, and a device 228 for measuring the outer diameter of the coated fiber 222. The coated fiber is then moved through a capstan 230 and is spooled for testing and storage prior to subsequent cable operations. The preservation of the intrinsically high strength of optical fibers is important during the ribboning, jacketing, connectorization and cabling of the fibers and in their service lifetime.

FIG. 3 illustrates a preform assembly 300 having two cladding tubes. The cladding tubes, 302 and 304, are collapsed around the preform core rod 306 by heating the cladding material and the preform core rod 306. This collapse helps concentrically align the preform core rod 306 and the cladding tubes, 302 and 304. As provided earlier, this may occur as a separate RIT preparation step. Generally, the length of the cladding tubes, 302 and 304, that is collapsed onto the preform core rod 306 to form a sealed end 310 may be, for example, approximately 25 to 35 centimeters. Fiber drawn from the interface region between the initially collapsed section 308 and the initially non-collapsed section typically does not meet certain performance characteristics.

In one embodiment of the present invention, the collapsed portion 308 of the RIT prepared preform assembly 300 is reduced from approximately 25 to 35 centimeters to approximately 2.5 to 7.5 centimeters. This shortened collapsed section, while still sufficient to concentrically align the preform core rod 306 in the cladding tube, 302 and 304, will be consumed during the start-up of the fiber drawing process and thus not be drawn into usable fiber. The section immediately beyond the collapsed section will produce optical fiber with acceptable performance characteristics.

The collapse of the cladding tubes, 302 and 304, onto the preform core rod 306 may also occur as part of the manufacturing process where the cladding tubes, 302 and 304, are collapsed onto the preform core rod 306 by the draw furnace that is used to soften the preform core rod 306 and cladding tubes, 302 and 304, so that the optical fiber may be drawn from them. In either case, the cladding material, 302 and 304, is continually collapsed around the preform core rod 306 as the assembly is fed into the manufacturing heating device and the optical fiber is drawn from the heated material.

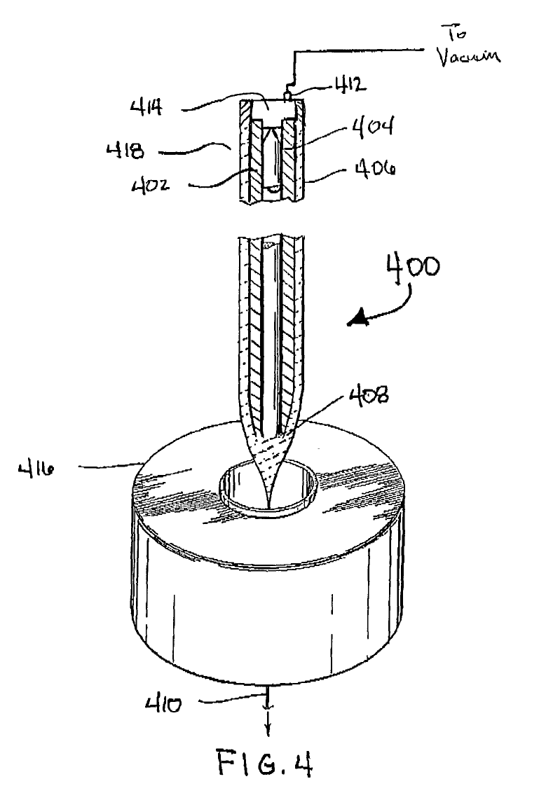

In FIG. 4, there is shown an exemplary embodiment of an arrangement in which one or more cladding tubes are collapsed onto a preform core rod during the drawing of optical fiber. A first cladding tube 402, which has an inner diameter only slightly greater than the outer diameter of a preform core rod 404, is caused to be disposed about the preform core rod 404 to form a preform assembly 400. In this embodiment, a second cladding tube 406, with an inner diameter only slightly greater than the outer diameter of the first cladding tube 402, is disposed about the first cladding tube 402 to form the preform assembly 400. The cladding tubes, 402 and 406, are caused to be sealed to the core rod 404 at a distal end 408, from which the optical fiber 410 is drawn. An opening 412 through a supporting chuck 414 to a source of vacuum, for example, is provided to allow control of the pressure within the tubes, 402 and 404, during the drawing of optical fiber. This arrangement maximizes the use of the relatively expensive preform assembly inasmuch as none of it is used in supporting the rod and tube from the overhead chuck 414.

The chuck 414 is supported to cause the preform assembly 400 to be suspended above a furnace 416. Then, as in the embodiment shown in FIG. 2, the preform assembly 400 is advanced into the furnace 416 to facilitate the drawing of an optical fiber 410 therefrom. Generally, as the length of the preform assembly 400 decreases, the vacuum applied to the assembly is constant vacuum within the preform assembly 400 during the manufacturing process. This constant vacuum generally serves to aid in the collapse of the cladding tubes, 402 and 406, onto the preform rod 404 and to remove particles and air from the preform assembly 400 with no deleterious effects when drawing optical fiber 410 from the distal end 408 and middle of the preform assembly 400. However, the constant vacuum may adversely affect the performance characteristics of optical fiber 410 drawn from the proximal end 418 of the preform assembly 400.

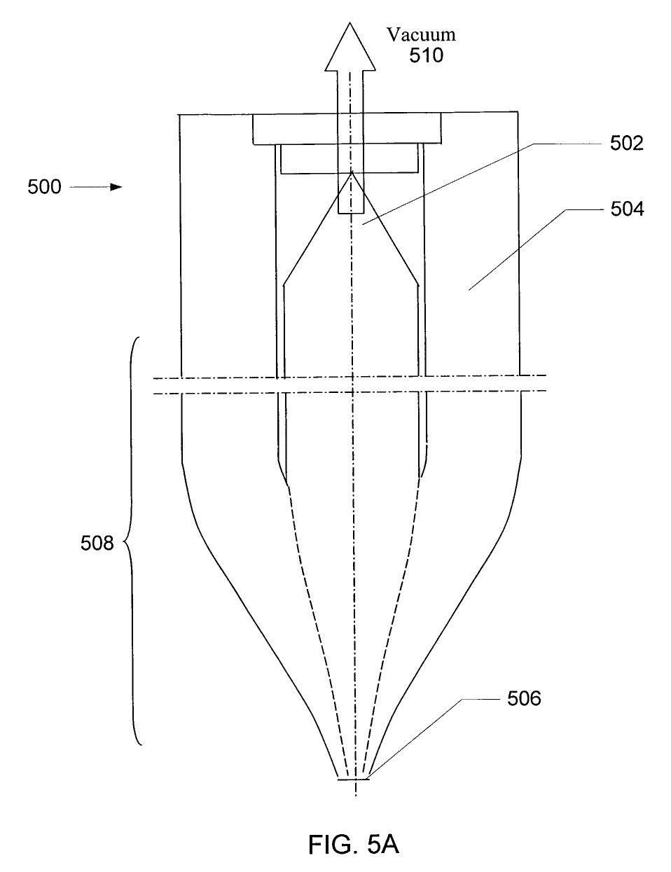

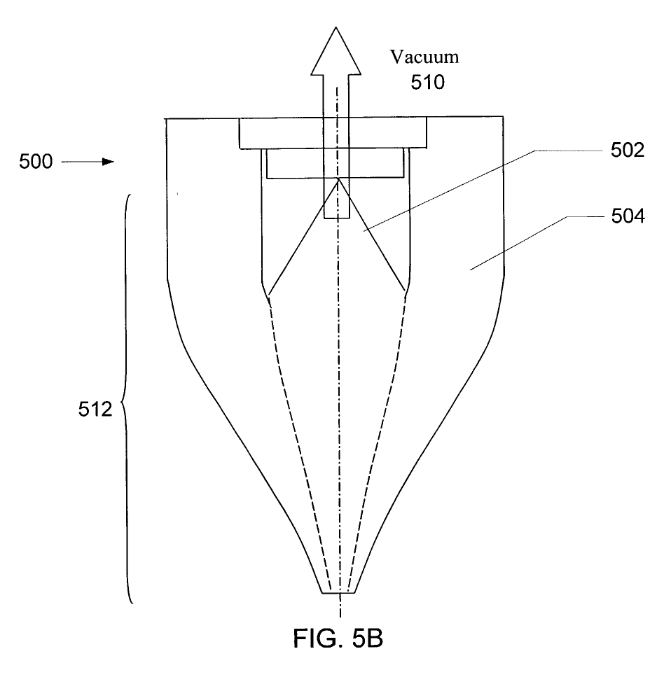

As illustrated in exemplary FIGS. 5A and 5B, a substantial amount of the preform core rod 502 and the cladding tube 504 is not molten when drawing optical fiber from the distal end 506 and middle 508 of the preform assembly 500. Therefore, the flow of the molten core rod 502 and cladding tube 504 as it is drawn into optical fiber is not significantly affected by the constant vacuum 510. However, as the proximal end 512 of the preform assembly 500 comes closer to the furnace, a substantial amount or all of the preform core rod 502 and the cladding tube 504 becomes molten or softened. When this happens, the flow of the molten core rod 502 and cladding tube 504 is affected by the constant vacuum 510 applied to the preform assembly 500. This change in the core rod and cladding tube flow rate results in a change of the ratio of the core outer diameter to the cladding outer diameter (“d/D ratio”) in optical fiber drawn from the proximal end 512 of the preform assembly 500 as compared to the d/D ratio of fiber drawn form the middle of the preform assembly.

This variance in the d/D ratio affects the performance characteristics of the optical fiber, including dispersion uniformity, eccentricity and mode field diameter. Typically, optical fiber drawn from the proximal end 512 must be scrapped because of these varying performance characteristics. Scrapping of this non-conforming optical fiber reduces the amount of optical fiber that may be drawn from a preform assembly 500 and is an inefficient use of manufacturing resources. Likewise, if no vacuum is applied to the preform assembly 500 as its proximal end 512 becomes molten, the d/D ratio of optical fiber drawn from such proximal end varies from that of the optical fiber drawn from the middle 508 and distal end 506 of the preform assembly 500. Generally, the variance of the performance characteristics of the optical fiber drawn from the proximal end 512 as compared to the performance characteristics of optical fiber drawn from the distal end 506 and middle 508 of the of the preform assembly 500 is known as “preform end effect.”

In one embodiment of the present invention, preform end effect is reduced through the use of a variable vacuum, as opposed to a constant vacuum. The variable vacuum reduces the vacuum applied to the preform assembly 600 as the proximal end 612 of the preform assembly 500 approaches the furnace. This reduction in the applied vacuum affects the flow rate of the molten preform core rod 502 and cladding tubes 504 as they are drawn into optical fiber, such that the d/D ratio of optical fiber drawn from and near the proximal end 512 of the preform assembly 500 is substantially similar to the d/D ratio of optical fiber drawn from the distal end 110 and middle 508 of the preform assembly 500.

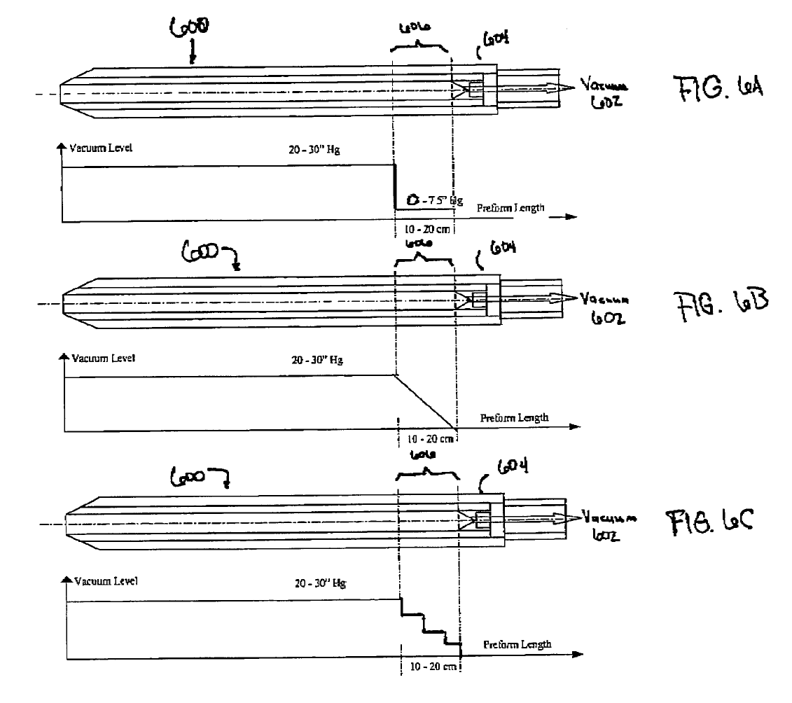

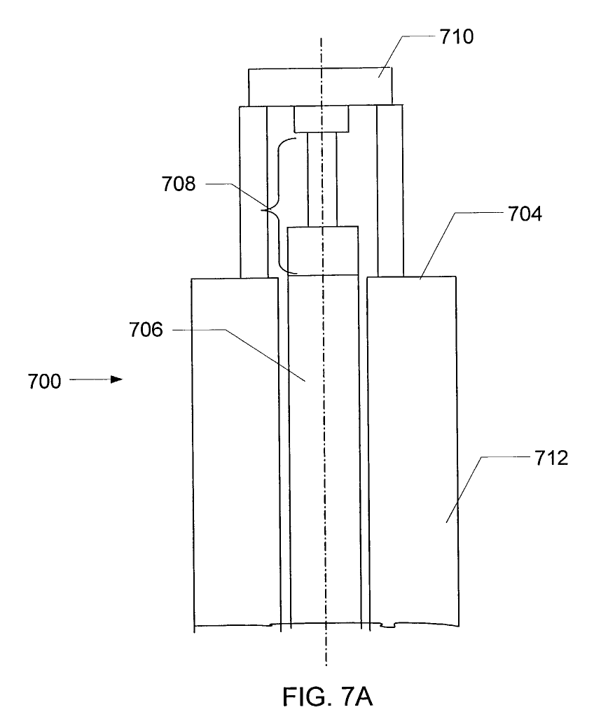

FIG. 6A illustrates one embodiment of the present invention that uses a variable vacuum. In this embodiment, the vacuum is changed from a first value to a second lower value, when the proximal end of the preform nears the furnace. For example, as illustrated, the vacuum applied to a preform assembly 600 may be essentially constant at approximately 20 to 30 inches Hg until the proximal end 604 of the preform assembly 600 is within 10 to 20 centimeters of the furnace (generally, this last 10 to 20 centimeters of the preform assembly 600 is referred to as the “end zone 606”). At that point, for example, the vacuum 602 applied to the preform assembly 600 may be reduced to approximately 0.00 to 7.5 inches Hg.

In an alternative embodiment illustrated in FIG. 6B, the vacuum is gradually decreased as the proximal end of the preform nears the furnace. In this embodiment, the vacuum is essentially constant at approximately 20 to 30 inches Hg until the proximal end 604 of the preform assembly 600 is within 10 to 20 centimeters of the furnace. Thereafter, the applied vacuum 602 may be gradually reduced as the end zone 606 of the preform assembly 600 is inserted into the furnace. The variation of the applied vacuum may be a negative slope as shown in FIG. 6B or in other manners (not shown). In yet another embodiment illustrated in FIG. 6C, the applied vacuum 602 may be stepped down in a “staircase” function (see FIG. 6C), although other forms of reducing the vacuum may be used.

The vacuum 602 may be varied by means known in the art such as, for example, a vacuum (pressure) regulator, a needle valve with a solenoid, etc.

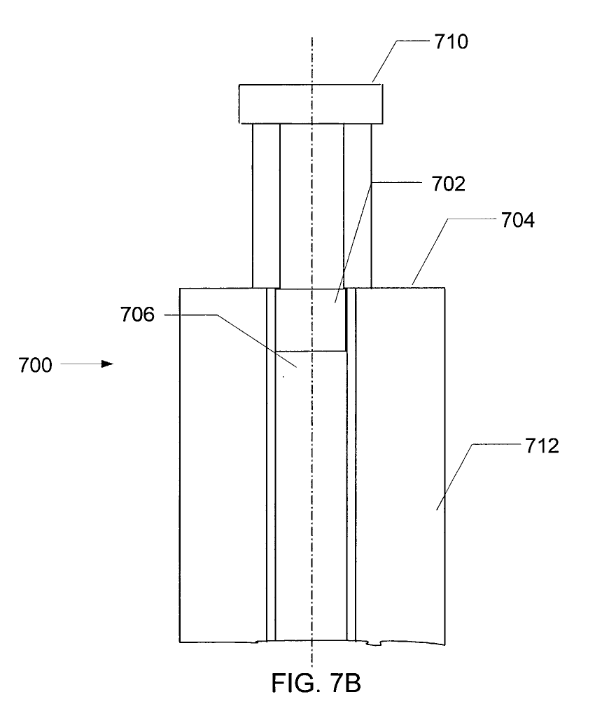

As an alternative to varying applied vacuum, the present invention may also reduce preform end effect using an intermediate rod such as a support rod or a dummy preform core rod, as shown in exemplary FIGS. 7A and 7B. One embodiment of the present invention, as shown in FIG. 7B, includes a dummy preform core rod 702 located at the proximal end 704 of the preform assembly 700. The dummy preform core rod 702, while generally comprised of glass, does not have to be of the same high quality synthetic glass from which the optical fiber is drawn, because the dummy preform core rod 702 is generally not drawn into fiber. In another embodiment, as shown in exemplary FIG. 7A, a support rod 708 is used at the proximal end 704 of the preform assembly 700 to position the preform core rod 706, thereby effectively extending the length of the preform core rod 706. The support rod is dimensioned such that the other end of the support rod is positioned against a chuck 710 used to suspend the preform assembly 700. In the embodiment of FIG. 7B, when the end zone 712 of the preform assembly 700 is reached during the draw of the optical fiber, the preform assembly core rod 706 and the dummy preform core rod 702 will be softened, and the molten material from the preform core rod 706 and the dummy preform core rod 702 will essentially flow continuously and uniformly. In the embodiment of FIG. 7A, when the end zone 712 of the preform assembly 700 is reached during draw of optical fiber, most of the support rod 708 will not become molten, and the solid support rod 708 will prevent the molten core rod glass from flowing upward, thus mitigating the preform end effect. Therefore, in both embodiments shown in FIGS. 7A and 7B, the d/D ratio of the optical fiber will not change substantially at the end zone of the preform assembly 700. Furthermore, the interface between the dummy preform core rod 702 or support rod 708 and the preform core rod 706 will provide a “signature” in the form of one or more of a speed and cladding excursion and an air line in the optical fiber. This excursion can be detected during the manufacturing process so that the dummy preform core rod 702 or support rod 708 material will not be used to draw optical fiber for commercial sale. Therefore, optical fiber may be drawn from substantially the entire length of the preform core rod 706 reducing waste and increasing the efficiency of the manufacturing process.

The above embodiments of the present invention, using a dummy preform core rod 702 or a support rod 708, may be used in the presence of a constant vacuum or a variable vacuum applied to the preform assembly 700. And if variable vacuum is used, the vacuum for the end zone 712 can be as low as zero. When the embodiment of dummy core rod shown in FIG. 7B is used in the presence of variable vacuum, the length of dummy core rod can be shortened so less glass will be wasted.

The table below, Table 1, summarizes the results achieved by the embodiments of this invention. For example, the amount of optical fiber that is non marketable because it does not meet dispersion criteria is reduced by 39.8% by using a variable vacuum only during the draw of the end zone of a preform assembly. If the collapsed portion of the RIT prepared preform assembly is reduced from approximately 25 to 35 centimeters to approximately 2.75 to 7.5 centimeters and the variable vacuum is used during the draw of the end zone of the preform assembly, the amount of optical fiber scrapped because on non-conformance with dispersion parameters is reduced by 64.5% over base. Improvement is also generally seen in eccentricity, MFD and ultimately composite fiber yield through the use of the present invention. Specifically, MFD is determined by fiber core diameter “d” and some other factors. A substantially constant d/D ratio will keep core diameter substantially constant, since the cladding diameter “D” is controlled precisely in the fiber draw process. Variable vacuum and support rod or dummy preform core rod will reduce the asymmetric force on core rod so that the eccentricity can be reduced.

TABLE 1

| | Without Variable | | With Variable |
|---|---|---|---|
| | Vacuum and | | Vacuum and |
| | Reduced RIT | With Variable | Reduced RIT |
| | Collapse | Vacuum Only | Collapse |
| Average Dispersion | Baseline | 39.8% | 64.5% |
| Scrap Improvement | | | |
| Over Base | | | |
| Composite Fiber | Baseline | 19.8% | 25.6% |
| Yield Improvement | | | |

Therefore, systems and methods are provided for increasing the amount of usable optical fiber that may be drawn from a preform assembly by reducing preform end effect through the use of a variable vacuum applied to the preform assembly during the draw of the optical fiber. Further, systems and methods of using a dummy preform core rod or a support rod are provided that also mitigates preform end effect.

Also, systems and methods of providing a preform assembly through a RIT technique whereby the length of the cladding tubes that are collapsed onto the preform core rod in order to concentrically align the cladding tubes and preform core rod and to seal the preform assembly is reduced such that the RIT collapsed portion will be consumed during start-up of draw operation and thus not go to usable fiber.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for forming an optical fiber comprising:
providing a preform assembly comprised of a preform core rod formed of glass and at least one cladding tube formed of glass surrounding the preform core rod;
drawing optical fiber from the preform assembly, wherein said drawing step draws optical fiber flowing from the preform core rod and cladding flowing from the cladding tube to thereby form a clad optical fiber; and
flowing the glass from the preform core rod and the cladding in a continuous and substantially constant flow during said drawing step to thereby control the ratio of the core outer diameter to the cladding outer diameter of the optical fiber.

2. A method according to claim 1, wherein the preform assembly has a proximal and distal end, wherein said drawing step draws fiber beginning at the distal end of the preform assembly, and wherein said flowing step flows the glass from the preform assembly in a continuous and substantially constant flow as said drawing step begins drawing fiber from the proximal end of the preform assembly to thereby reduce preform end effect.

3. A method according to claim 1, wherein said flowing step comprises:
applying a vacuum to the preform assembly; and
varying the amount of vacuum applied during draw of the optical fiber to thereby control the flow rate from the preform core rod and cladding tube.

4. A method according to claim 3, wherein said applying step applies a constant vacuum during a first portion of the draw of the optical fiber from the preform assembly and varies the vacuum during a second portion of the draw of the optical fiber.

5. A method according to claim 3, wherein said applying step applies a first vacuum pressure during a first portion of the draw of the optical fiber from the preform assembly and a second vacuum pressure during a second portion of the draw of the optical fiber, wherein the first vacuum pressure is greater than the second vacuum pressure.

6. A method according to claim 3, wherein said applying step applies a first vacuum pressure during a first portion of the draw of the optical fiber from the preform assembly and a varying vacuum pressure during a second portion of the draw that decreases over time.

7. A method according to claim 5, wherein said applying step applies a varying vacuum pressure during a second portion of the draw that decreases linearly over time.

8. A method according to claim 5, wherein said applying step applies a varying vacuum pressure during a second portion of the draw that decreases incrementally over time.

9. A method according to claim 3, wherein said applying step applies a first vacuum pressure in the range of 20 to 30 inches Hg and a second vacuum pressure during a second portion of the draw of the optical fiber in the range of 0.00 and 7.5 inches Hg.

10. A method according to claim 1, wherein the preform assembly has proximal and distal ends, wherein the proximal end is secured while optical fiber is drawn from the distal end, and wherein an end zone is defined adjacent to the proximal end,
wherein said flowing step comprises:
applying a first vacuum pressure to the preform assembly as it is heated and optical fiber is drawn from a section of the preform assembly defined from the distal end to the end zone of the preform assembly; and
applying a second vacuum pressure to the preform assembly during a time when the end zone of the preform assembly is drawn into optical fiber.

11. A method according to claim 10, wherein the preform assembly has an end zone extending from the proximal end toward the distal end of the preform for a distance in the range of 6 to 20 centimeters in length.

12. A method according to claim 1, wherein said flowing step reduces the rod in tube (RIT) effect on the preform core rod to a length in the range of 2.5 to 7.5 centimeters.

13. A method according to claim 1, wherein said providing step further provides a chuck for securing the preform assembly and an intermediate rod between the proximal end of the preform assembly and the chuck.

14. An apparatus for drawing optical fiber from a preform assembly having a preform core rod formed of glass and at least one cladding tube formed of glass surrounding the preform core rod, said apparatus comprising:
a draw device for drawing optical fiber from the preform assembly, wherein said draw device draws optical fiber flowing from the preform core rod and cladding flowing from the cladding tube to thereby form a clad optical fiber; and
a flow control device for controlling the flow of glass from the preform core rod such that the glass flows in a continuous and substantially constant flow when said draw device draws optical fiber to thereby control the ratio of the core outer diameter to the cladding outer diameter of an optical fiber.

15. An apparatus according to claim 14, wherein said preform assembly has a proximal and distal end, wherein said draw device draws fiber beginning at the distal end of the preform assembly, and wherein said flow control device flows the glass from the preform assembly in a continuous and substantially constant flow as said drawing device begins drawing fiber from the proximal end of the preform assembly to thereby reduce preform end effect.

16. An apparatus according to claim 14, wherein said flow control device comprises a vacuum device in fluid communication with said preform assembly for applying a vacuum thereto, wherein said vacuum device varies the amount of vacuum applied during draw of the optical fiber to thereby control the flow rate from the preform core rod and cladding tube.

17. An apparatus according to claim 16, wherein said vacuum device applies a constant vacuum during a first portion of the draw of the optical fiber from the preform assembly and varies the vacuum during a second portion of the draw of the optical fiber.

18. An apparatus according to claim 16, wherein said vacuum device applies a first vacuum pressure during a first portion of the draw of the optical fiber from the preform assembly and a second vacuum pressure during a second portion of the draw of the optical fiber, wherein the first vacuum pressure is greater than the second vacuum pressure.

19. An apparatus according to claim 16, wherein said vacuum device applies a first vacuum pressure during a first portion of the draw of the optical fiber from the preform assembly and a varying vacuum pressure during a second portion of the draw that decreases over time.

20. An apparatus according to claim 18, wherein said vacuum device applies a varying vacuum pressure during a second portion of the draw that decreases linearly over time.

21. An apparatus according to claim 18, wherein said vacuum device applies a varying vacuum pressure during a second portion of the draw that decreases incrementally over time.

22. An apparatus according to claim 16, wherein said vacuum device applies a first vacuum pressure in the range of 20 to 30 inches Hg and a second vacuum pressure during a second portion of the draw of the optical fiber in the range of 0.00 and 7.5 inches Hg.

23. An apparatus according to claim 14, wherein said preform assembly has proximal and distal ends, wherein the proximal end is secured while optical fiber is drawn from the distal end, and wherein an end zone is defined adjacent to the proximal end, wherein said vacuum devices applies a first vacuum pressure to the preform assembly as it is heated and optical fiber is drawn from a section of the preform assembly defined from the distal end to the end zone of the preform assembly and applies a second vacuum pressure to the preform assembly during a time when the end zone of the preform assembly is drawn into optical fiber.

24. An apparatus according to claim 23, wherein said preform assembly has an end zone extending from the proximal end toward the distal end of the preform for a distance in the range of 6 to 20 centimeters in length.

25. An apparatus according to claim 14, wherein said vacuum device reduces the rod in tube (RIT) effect on the preform core rod to a length in the range of 2.5 to 7.5 centimeters.

26. An apparatus according to claim 14 further comprising:
a chuck in communication with said preform assembly for securing said preform assembly during draw of optical fiber from said preform assembly; and
an intermediate rod in communication with and between the proximal end of the preform assembly and said chuck.

27. A method for forming an optical fiber comprising the steps of:
providing a preform assembly comprising a preform core rod, the preform assembly having proximal and distal ends, wherein optical fiber is drawn from the distal end;
providing a chuck for securing the preform assembly;
providing an intermediate rod between the proximal end of the preform assembly and the chuck;
drawing optical fiber from the distal end of the preform assembly,
wherein the intermediate rod provided in said providing step reduces preform end effect in manufacture of the optical fiber.

28. A method according to claim 27, wherein the intermediary rod provided in said providing step is a dummy preform core rod formed of glass.

29. A method according to claim 27, wherein the intermediate rod provided in said providing step is a support rod that prevents molten portions of the preform core rod from flowing in a direction opposite of the direction in which the optical fiber is drawn in said drawing step.

30. A method according to claim 27 further comprising the steps of
applying a vacuum to the preform assembly; and
varying the amount of vacuum applied during draw of the optical fiber to thereby control a flow rate of the preform core rod and cladding tube.

31. An apparatus for drawing optical fiber from a preform assembly having proximal and distal ends and a preform core rod, said apparatus comprising:
a chuck in communication with the preform assembly for securing the preform assembly during draw of optical fiber from the distal end of the preform assembly;
an intermediate rod in communication with and between the proximal end of the preform assembly and said chuck; and
a drawing device in communication with the distal end of said preform assembly for drawing optical fiber from the preform assembly,
wherein said intermediate rod reduces preform end effect in manufacture of the optical fiber.

32. An apparatus according to claim 31, wherein said intermediate rod is dummy preform core formed of glass.

33. A method according to claim 31, wherein said intermediate is a support rod that prevents molten portions of the preform core rod from flowing in a direction opposite of the direction in which the optical fiber is drawn.

34. An apparatus according to claim 31 further comprising a vacuum device in fluid communication with said preform assembly for applying a vacuum thereto, wherein said vacuum device varies the amount of vacuum applied during draw of the optical fiber to thereby control the flow rate from the preform core rod and a cladding tube formed of glass.
